(19) United States
(12) Patent Application Publication
(10) Pub. No.: US 2008/0139741 A1
(43) Pub. Date: Jun. 12, 2008

(54) Aqueous Polyurethane Dispersions With A Small Content Of Cyclic Compounds

(75) Inventors: Andre Burghardt, Bobenheim-Roxheim (DE); Barbel Meyer, Lauta (DE); Karl Haberle, Speyer (DE); Karl-Heinz Schumacher, Neustadt (DE); Ulrike Licht, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/815,340

(22) PCT Filed: Feb. 9, 2006
(86) PCT No.: PCT/EP06/50812

§ 371 Date: Aug. 2, 2007

(30) Foreign Application Priority Data
Feb. 11, 2005 (DE) 102005006551.1

(51) Int. Cl. C08G 18/02

(52) U.S. Cl. 524/591; 427/393.5; 156/331.7

(57) ABSTRACT

Aqueous dispersions comprising a polyurethane synthesized from

a) diisocyanates,

b) diols of which

b₁) from 10 to 100 mol %, based on the total amount of diols (b), have a molecular weight of from 500 to 5 000, and

b₂) from 0 to 90 mol %, based on the total amount of diols (b), have a molecular weight of from 60 to 500 g/mol,

c) monomers other than the monomers (a) and (b), containing at least one isocyanate group or at least one isocyanate-reactive group and further carrying at least one hydrophilic group or potentially hydrophilic group by means of which the polyurethane is made dispersible in water,

d) if appropriate, further, polyfunctional compounds other than the monomers (a) to (c), containing reactive groups which are alcoholic hydroxyl groups, primary or secondary amino groups or isocyanate groups, and

e) if appropriate, monofunctional compounds other than the monomers (a) to (d), containing a reactive group which is an alcoholic hydroxyl group, a primary or secondary amino group or an isocyanate group,

wherein the diols b₁ comprise less than 0.5 part by weight of cyclic compounds per 100 parts by weight of diols b1.

The present invention relates to aqueous dispersions comprising a polyurethane synthesized from

a) diisocyanates,

b) diols of which

b₁) from 10 to 100 mol %, based on the total amount of diols (b), have a molecular weight of from 500 to 5 000, and

b₂) from 0 to 90 mol %, based on the total amount of diols (b), have a molecular weight of from 60 to 500 g/mol,

c) monomers other than the monomers (a) and (b), containing at least one isocyanate group or at least one isocyanate-reactive group and further carrying at least one hydrophilic group or potentially hydrophilic group by means of which the polyurethane is made dispersible in water,

d) if appropriate, further, polyfunctional compounds other than the monomers (a) to (c), containing reactive groups which are alcoholic hydroxyl groups, primary or secondary amino groups or isocyanate groups, and

e) if appropriate, monofunctional compounds other than the monomers (a) to (d), containing a reactive group which is an alcoholic hydroxyl group, a primary or secondary amino group or an isocyanate group,

wherein the diols b1 comprise less than 0.5 part by weight of cyclic compounds per 100 parts by weight of diols b1.

The invention further relates to methods of coating, adhesively bonding, and impregnating articles made of different materials with these dispersions, to articles coated, adhesively bonded, and impregnated with these dispersions, and to the use of the dispersions of the invention as hydrolysis-resistant coating materials.

The use of aqueous dispersions comprising polyurethanes (PU dispersions for short) as binders in adhesives, especially laminated adhesives, or coating materials, for textile or leather for example, or in paints and varnishes is known.

A disadvantage in this context is that the raw materials used, particularly the diols b1, comprise cyclic compounds such as, for example, cyclic esters or cyclic ethers. These cyclic compounds generally do not have any isocyanate-reactive groups, and so are also present in the polyurethane following the preparation. Where the polyurethanes are processed to adhesives or coatings, the cyclic compounds remain in part in the polymer, where they exert an unwanted plasticizing effect. For the other part, the cyclic compounds, during use of the PU dispersions, may migrate from the adhesives or coatings produced therewith, and they make a substantial contribution to what is called the fogging effect. Another frequent occurrence is the migration of the cyclic compounds to the boundary of the adhesive or coating film, where they lessen the adhesion of the film to the substrate.

It is known from DE-A 103 24 306 that polyurethane dispersions prepared from polyhydroxy compounds which have been freed from volatile compounds by distillation under defined conditions are suitable for producing low-fogging coatings.

Found accordingly have been the aqueous dispersions defined at the outset. The aqueous dispersions of the invention comprise polyurethanes which in addition to other monomers are derived from diisocyanates a), with the diisocyanates a) used being preferably those which are commonly employed in polyurethane chemistry.

Monomers (a) are, in particular, diisocyanates X(NCO)₂, where X is an aliphatic hydrocarbon radical of 4 to 12 carbons, a cycloaliphatic or aromatic hydrocarbon radical of 6 to 15 carbons or an araliphatic hydrocarbon radical of 7 to 15 carbons. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis and the cis/trans isomer, and mixtures of these compounds.

Such diisocyanates are available commercially.

Particularly important mixtures of these isocyanates are the mixtures of the respective structural isomers of diisocyanatotoluene and diisocyanatodiphenylmethane, especially the mixture comprising 80 mol % of 2,4-diisocyanatotoluene and 20 mol % of 2,6-diisocyanatotoluene. In addition, the mixtures of aromatic isocyanates, such as 2,4-diisocyanatotoluene and/or 2,6-diisocyanatotoluene, with aliphatic or cycloaliphatic isocyanates, such as hexamethylene diisocyanate or IPDI, are particularly advantageous, the preferred proportion of aliphatic to aromatic isocyanates being from 4:1 to 1:4.

In addition to the abovementioned isocyanates, other isocyanates which can be employed as compounds to synthesize the polyurethanes are those which carry not only the free isocyanate groups but also further, capped isocyanate groups, examples being uretdione groups.

With a view to good film formation and elasticity, diols (b) which are ideally suitable are those diols (b1) which have a relatively high molecular weight of from about 500 to 5 000, preferably from about 1 000 to 3 000 g/mol.

The diols (b1) are, in particular, polyesterpolyols, which are known, for example, from Ullmanns Encyklopädie der technischen Chemie, 4th edition, vol. 19, pp. 62 to 65. It is preferred to employ polyesterpolyols that are obtained by reacting dihydric alcohols with dibasic carboxylic acids. Instead of the free polycarboxylic acids it is also possible to use the corresponding polycarboxylic anhydrides or corresponding polycarboxylic esters of lower alcohols, or mixtures thereof, to prepare the polyesterpolyols. The polycarboxylic acids can be aliphatic, cycloaliphatic, araliphatic, aromatic or heterocyclic and can be optionally substituted, by halogen atoms, for example, and/or optionally unsaturated. Examples are suberic, azelaic, phthalic, and isophthalic acid, phthalic, tetrahydrophthalic, hexahydrophthalic, tetrachlorophthalic, endomethylenetetrahydrophthalic, glutaric and maleic anhydride, maleic acid, fumaric acid and dimeric fatty acids. Preference is given to dicarboxylic acids of the formula HOOC—(CH₂)_{y}—COOH, where y is a number from 1 to 20, preferably an even number from 2 to 20, examples being succinic, adipic, sebacic and dodecanedicarboxylic acids.

Examples of suitable polyhydric alcohols are ethylene glycol, 1,2-propanediol, 1,3-propanediol, 1,3-butanediol, 1,4-butenediol, 1,4-butynediol, 1,5-pentanediol, neopentyl glycol, bis(hydroxymethyl)cyclohexanes such as 1,4-bis(hydroxymethyl)cyclohexane, 2-methyl-1,3-propanediol, methylpentanediols, and also diethylene glycol, triethylene glycol, tetraethylene glycol, polyethylene glycol, dipropylene glycol, polypropylene glycol, dibutylene glycol and polybutylene glycols. Preference is given to alcohols of the formula HO—(CH₂)ₓ—OH, where x is a number from 1 to 20, preferably an even number from 2 to 20. Examples of such alcohols are ethylene glycol, 1,4-butanediol, 1,6-hexanediol, 1,8-octanediol and 1,12-dodecanediol. Preference extends to neopentyl glycol.

Also suitable are polycarbonatediols, as can be obtained, for example, by reaction of phosgene with an excess of the low molecular mass alcohols cited as synthesis components for the polyesterpolyols.

Lactone-based polyesterdiols are also suitable, these being homopolymers or copolymers of lactones, preferably hydroxy-terminal adducts of lactones with suitable difunctional starter molecules. Suitable lactones are preferably those derived from compounds of the formula HO—(CH₂)_{z}—COOH, where z is from 1 to 20 and one hydrogen of a methylene unit can also be substituted by a C₁-C₄-alkyl. Examples are e-caprolactone, β-propiolactone, g-butyrolactone and/or methyl-e-caprolactone, and mixtures thereof. Examples of suitable starter components are the low molecular mass dihydric alcohols cited above as synthesis components for the polyesterpolyols. The corresponding polymers of e-caprolactone are particularly preferred. Lower polyesterdiols or polyetherdiols can also be employed as starters for preparing the lactone polymers. Instead of the polymers of lactones it is also possible to employ the corresponding, chemically equivalent polycondensates of the hydroxy carboxylic acids which correspond to the lactones.

Further suitable monomers (b1) are polyetherdiols. They are obtainable in particular by addition polymerization of ethylene oxide, propylene oxide, butylene oxide, tetrahydrofuran, styrene oxide or epichlorohydrin with itself, in the presence, for example, of BF₃, or by addition reaction of these compounds, if appropriate in a mixture or in succession, onto starter components containing reactive hydrogens, such as alcohols or amines, examples being water, ethylene glycol, 1,2-propanediol, 1,3-propanediol, 1,2-bis(4-hydroxydiphenyl)propane or aniline. Particular preference is given to polytetrahydrofuran having a molecular weight of from 240 to 5 000 and, in particular, from 500 to 4 500.

Likewise suitable are polyhydroxyolefins, preferably those having 2 terminal hydroxyls, examples being a,w-dihydroxypolybutadiene, a,w-dihydroxypolymethacrylates or a,w-dihydroxypolyacrylates as monomers (c1). Such compounds are known, for example, from EP-A-0622378. Further suitable polyols are polyacetals, polysiloxanes and alkyd resins.

The polyols can also be employed as mixtures in proportions of from 0.1:1 to 1:9.

The hardness and the modulus of elasticity of the polyurethanes can be raised by employing as diols (b) not only the diols (b1) but also low molecular mass diols (b2) having a molecular weight of from about 60 to 500, preferably from 62 to 200 g/mol.

The diols b1 comprise less than 0.5%, in particular less than 0.2%, and very preferably less than 0.1% by weight of cyclic compounds. These cyclic compounds are, in particular, cyclic esters and cyclic ethers. They are formed as byproducts of the preparation of the polyesterols or polyetherols. The molar weight of the cyclic compounds is generally less than 500 g/mol, in particular less than 300 g/mol.

The cyclic compounds can be removed from diols b1 before these diols are reacted further. For that purpose, for example, the diols can be subjected to a distillative treatment. The amount of cyclic compounds can also be lowered by introducing gases such as nitrogen, argon, steam or carbon dioxide, for example.

Treatment with suitable wash liquids such as water, for example, is another possible way of reducing the cyclic-compound content.

Compounds employed as monomers (b2) are in particular the synthesis components of the short-chain alkanediols cited for the preparation of polyesterpolyols, preference being given to the unbranched diols having from 2 to 12 carbons and an even number of carbons, and to 1,5-pentanediol and neopentyl glycol.

The proportion of the diols (b1), based on the total amount of diols (b), is preferably from 10 to 100 mol %, and the proportion of monomers (b2), based on the total amount of diols (b), is from 0 to 90 mol %. With particular preference the ratio of the diols (b1) to the monomers (b2) is from 0.1:1 to 5:1, more preferably from 0.2:1 to 2:1.

In order to render the polyurethanes dispersible in water they are synthesized not only from components (a), (b) and if appropriate (d) but also from monomers (c) which are different from components (a), (b) and (d) and which carry at least one isocyanate group or at least one isocyanate-reactive group and, in addition, at least one hydrophilic group or a group which can be converted into a hydrophilic group. In the text below the term hydrophilic groups or potentially hydrophilic groups is shortened to (potentially) hydrophilic groups. The (potentially) hydrophilic groups react with isocyanates much more slowly than do the functional groups of the monomers used to build up the polymer main chain.

The proportion of components having (potentially) hydrophilic groups among the total amount of components (a), (b), (c), (d) and (e) is generally such that the molar amount of the (potentially) hydrophilic groups, based on the amount by weight of all monomers (a) to (e), is from 30 to 1 000, preferably from 50 to 500 and, with particular preference, from 80 to 300 mmol/kg.

The (potentially) hydrophilic groups can be nonionic or, preferably, (potentially) ionic hydrophilic groups.

Suitable nonionic hydrophilic groups are especially polyethylene glycol ethers made up of preferably from 5 to 100, more preferably from 10 to 80, repeating ethylene oxide units. The amount of polyethylene oxide units is generally from 0 to 10, preferably from 0 to 6, % by weight, based on the amount by weight of all monomers (a) to (e).

Preferred monomers having nonionic hydrophilic groups are polyethylene oxide diols, polyethylene oxide monools, and the reaction products of a polyethylene glycol and a diisocyanate which carry a terminally etherified polyethylene glycol radical. Such diisocyanates and processes for their preparation are specified in the patents U.S. Pat. No. 3,905,929 and U.S. Pat. No. 3,920,598.

Ionic hydrophilic groups are, in particular, anionic groups, such as the sulfonate, carboxylate and phosphate groups in the form of their alkali metal salts or ammonium salts, and also cationic groups such as ammonium groups, especially protonated tertiary amino groups or quaternary ammonium groups.

Potentially ionic hydrophilic groups are, in particular, those which can be converted by simple neutralization, hydrolysis or quaternization reactions into the abovementioned ionic hydrophilic groups, examples thus being carboxyl or tertiary amino groups.

(Potentially) ionic monomers (c) are described in detail in, for example, Ullmanns Encykiopädie dertechnischen Chemie, 4th edition, vol. 19, pp. 311-313 and, for example, in DE-A 14 95 745.

Monomers having tertiary amino groups, in particular, are of especial practical importance as (potentially) cationic monomers (c), examples being: tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, N-aminoalkyldialkylamines, the alkyls and alkanediyl units of these tertiary amines consisting independently of one another of 1 to 6 carbons. Also suitable are polyethers containing tertiary nitrogens and preferably two terminal hydroxyls, as are obtainable in a conventional manner by, for example, alkoxylating amines having two hydrogens attached to the amine nitrogen, examples being methylamine, aniline and N,N′-dimethylhydrazine. Polyethers of this kind generally have a molar weight of from 500 to 6 000 g/mol.

These tertiary amines are converted either with acids, preferably strong mineral acids such as phosphoric acid, sulfuric acid or hydrohalic acids, or strong organic acids, or by reaction with appropriate quaternizing agents such as C₁-C₆-alkyl halides or benzyl halides, for example bromides or chlorides, into the ammonium salts.

Suitable monomers having (potentially) anionic groups are, conventionally, aliphatic, cycloaliphatic, araliphatic or aromatic carboxylic and sulfonic acids which carry at least one alcoholic hydroxyl or at least one primary or secondary amino group. Preference is given to dihydroxyalkylcarboxylic acids, especially those having from 3 to 10 carbons, as are also described in U.S. Pat. No. 3,412,054. Particular preference is given to compounds

of the formula (c₁)

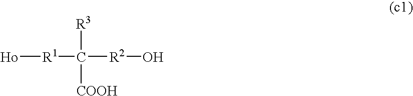

where R¹ and R² are C₁-C₄-alkanediyl and R³ is C₁-C₄-alkyl, and especially to dimethyl-olpropionic acid (DMPA).

Corresponding dihydroxysulfonic and dihydroxyphosphonic acids, such as 2,3-dihydroxypropanephosphonic acid, are also suitable.

Compounds otherwise suitable are dihydroxy compounds having a molecular weight of more than 500 up to 10 000 g/mol and at least 2 carboxylate groups, which are known from DE-A 39 11 827. They are obtainable by reacting dihydroxy compounds with tetra-carboxylic dianhydrides, such as pyromellitic dianhydride or cyclopentanetetracarboxylic dianhydride, in a molar ratio of from 2:1 to 1.05:1 in a polyaddition reaction. Particularly suitable dihydroxy compounds are the monomers (b2) listed as chain extenders, and the diols (b1).

Suitable monomers (c) having isocyanate-reactive amino groups are amino carboxylic acids such as lysine, β-alanine or the adducts specified in DE-A-20 34 479 of aliphatic diprimary diamines with a,β-unsaturated carboxylic or sulfonic acids.

Such compounds conform for example to the formula (c₂)

H₂N—R⁴—NH—R⁵—X (c2)

where

R⁴ and R⁵ independently of one another are a C₁-C₆-alkanediyl unit, preferably ethylene,

### and X is COOH or SO₃H.

Particularly preferred compounds of the formula (c₂) are N-(2-aminoethyl)-2-aminoethanecarboxylic acid and N-(2-aminoethyl)-2-aminoethanesulfonic acid and the corresponding alkali metal salts, Na being the particularly preferred counterion.

Also particularly preferred are the adducts of the abovementioned aliphatic diprimary diamines with 2-acrylamido-2-methylpropanesulfonic acid, as are described, for example, in DE Patent 19 54 090.

Insofar as monomers having potentially ionic groups are employed, their conversion into the ionic form can take place before or during, but preferably after, the isocyanate polyaddition reaction, since the solubility of the ionic monomers in the reaction mixture is in many cases poor. With particular preference, the sulfonate or carboxylate groups are in the form of their salts with an alkali metal ion or ammonium ion as counterion.

The monomers (d), which are different from the monomers (a) to (c) and which are, if appropriate, constituents of the polyurethane, serve generally for crosslinking or chain extension. They are generally nonphenolic alcohols with a functionality of more than two, amines having 2 or more primary and/or secondary amino groups, and compounds which in addition to one or more alcoholic hydroxyls carry one or more primary and/or secondary amino groups.

Examples of alcohols having a functionality of more than 2 which can be used to establish a certain degree of branching or crosslinking are trimethylolpropane, glycerol, and sugars.

Also suitable are monoalcohols which in addition to the hydroxyl group carry a further isocyanate-reactive group, such as monoalcohols having one or more primary and/or secondary amino groups; for example, monoethanolamine.

Polyamines having 2 or more primary and/or secondary amino groups are employed in particular when chain extension and/or crosslinking is to take place in the presence of water, since amines generally react more quickly with isocyanates than do alcohols or water. This is in many cases necessary when the desire is for aqueous dispersions of crosslinked polyurethanes, or polyurethanes of high molar weight. In such cases a procedure is followed in which prepolymers with isocyanate groups are prepared, are rapidly dispersed in water and then are subjected to chain extension or crosslinking by adding compounds having two or more isocyanate-reactive amino groups.

Amines suitable for this purpose are, in general, polyfunctional amines with a molar weight in the range from 32 to 500 g/mol, preferably from 60 to 300 g/mol, comprising at least two amino groups selected from the group consisting of primary and secondary amino groups. Examples are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane.

The amines can also be employed in blocked form, for example in the form of the corresponding ketimines (see e.g. CA-A-1 129 128), ketazines (cf. e.g. U.S. Pat. No. 4,269,748) or amine salts (see U.S. Pat. No. 4,292,226). Oxazolidines too, as are used, for example, in U.S. Pat. No. 4,192,937, are capped polyamines which can be employed to chain extend the prepolymers in the preparation of the novel polyurethanes. When capped polyamines of this kind are used they are generally mixed with the prepolymers in the absence of water and this mixture is subsequently mixed with the dispersion water or with a portion thereof so that the corresponding polyamines are liberated by hydrolysis.

It is preferred to use mixtures of diamines and triamines, especially mixtures of isophoronediamine (IPDA) and diethylenetriamine (DETA).

The polyurethanes comprise preferably from 1 to 30 mol %, especially from 4 to 25 mol %, based on the total amount of components (b) and (d), of a polyamine having at least 2 isocyanate-reactive amino groups, as monomer (d).

Examples of alcohols having a functionality of more than 2 which can be used to establish a certain degree of branching or crosslinking are trimethylolpropane, glycerol, and sugars.

For the same purpose it is also possible, as monomers (d), to employ isocyanates with a functionality of more than two. Examples of commercial compounds are the isocyanurate or the biuret of hexamethylene diisocyanate.

Monomers (e), which can additionally be used if appropriate, are monoisocyanates, monoalcohols and monoprimary and monosecondary amines. In general their proportion is not more than 10 mol %, based on the total molar amount of the monomers. These monofunctional compounds usually carry other functional groups, such as olefinic groups or carbonyl groups, and serve to introduce functional groups into the polyurethane which enable the polyurethane to be dispersed or crosslinked or to undergo further polymer-analogous reaction. Monomers suitable for this purpose are isopropenyl-a,a-dimethylbenzyl isocyanate (TMI) and esters of acrylic or methacrylic acid, such as hydroxyethyl acrylate or hydroxyethyl methacrylate.

In the field of polyurethane chemistry it is general knowledge how the molecular weight of the polyurethanes can be adjusted by choosing the proportions of the co-reactive monomers and by the arithmetic mean of the number of reactive functional groups per molecule.

Components (a) to (e) and their respective molar amounts are normally chosen such that the ratio A:B, where

A) is the molar amount of isocyanate groups and

B) is the sum of the molar amount of the hydroxyl groups and the molar amount of the functional groups which are able to react with isocyanates in an addition reaction,

is from 0.5:1 to 2:1, preferably from 0.8:1 to 1.5 and, with particular preference, from 0.9:1 to 1.2:1. With very particular preference the ratio A:B is as close as possible to 1:1.

The monomers (a) to (e) employed carry on average usually from 1.5 to 2.5, preferably from 1.9 to 2.1 and, with particular preference, 2.0 isocyanate groups and/or functional groups which are able to react with isocyanates in an addition reaction.

The polyaddition of components (a) to (e) for preparing the polyurethane present in the aqueous dispersions of the invention takes place at reaction temperatures of 20 to 180° C., preferably 50 to 150° C., under atmospheric pressure or under autogenous pressure.

The reaction times required are from 1 to 20 hours, especially from 1.5 to 10 hours. It is known in the field of polyurethane chemistry how the reaction time is influenced by a host of parameters such as temperature, monomer concentration and monomer reactivity.

Suitable polymerization apparatus for conducting the polyaddition comprise stirred tanks, especially when solvents are used to ensure a low viscosity and effective heat dissipation.

Preferred solvents are of unlimited miscibility with water, have a boiling point of from 40 to 100° C. under atmospheric pressure, and react slowly, if at all, with the monomers.

The dispersions are usually prepared by one of the following processes:

In the acetone process an ionic polyurethane is prepared from components (a) to (c) in a water-miscible solvent which boils at below 100° C. under atmospheric pressure. Water is added until a dispersion is formed in which water is the continuous phase.

The prepolymer mixing process differs from the acetone process in that rather than a fully reacted (potentially) ionic polyurethane it is a prepolymer carrying isocyanate groups which is prepared first of all. In this case, the components are chosen such that the above-defined ratio A:B is greater than 1.0 to 3, preferably 1.05 to 1.5. The prepolymer is first dispersed in water and then crosslinked, if appropriate by reacting the isocyanate groups with amines which carry more than 2 isocyanate-reactive amino groups, or is chain extended with amines which carry 2 isocyanate-reactive amino groups. Chain extension also takes place when no amine is added. In this case, isocyanate groups are hydrolyzed to amino groups, which react with residual isocyanate groups of the prepolymers and so extend the chain.

If a solvent has been used in preparing the polyurethane, it is usual to remove the majority of the solvent from the dispersion, for example by distillation under reduced pressure. The dispersions preferably have a solvent content of less than 10% by weight and are, with particular preference, free from solvents.

The dispersions generally have a solids content of from 10 to 75, preferably from 20 to 65, % by weight and a viscosity of from 10 to 1 500 mPas (measured at 20° C. and at a shear rate of 250 s⁻¹).

Through the use of diols b1 having a low cyclic-compound content the content in the polyurethane dispersions is also less than 0.5 part by weight, in particular less than 0.2 part by weight, and very preferably less than 0.1 part by weight per 100 parts by weight of polyurethane (solids).

The low level of cyclic compounds in b1 and in the polyurethane dispersion is achieved by separating off the cyclic compounds from the diols b1 even before said diols are reacted (see above).

The polyurethane dispersions are suitable as binders for adhesives, coating materials for any of a very wide variety of substrates, including textile and leather, and in particular are also suitable for paints and varnishes.

The adhesives, coating materials or paints and varnishes may consist solely of the polyurethane dispersion or may comprise further constituents.

They may comprise commercially customary auxiliaries and additives such as blowing agents, defoamers, emulsifiers, thickeners and thixotropic agents, colorants such as dyes and pigments, and tackifying resins (tackifiers).

The dispersions of the invention are suitable for coating articles made of metal, plastic, paper, textile, leather or wood by applying said dispersions in the form of a film to these articles in accordance with generally customary techniques, such as by spraying or knife coating, for example, and drying the dispersion.

The aqueous dispersions of the invention are distinguished by qualities which include a relatively high elasticity modulus, a relatively high breaking stress, a relatively low breaking elongation, and an improved adhesion to the substrate.

1. An aqueous dispersion comprising a polyurethane synthesized from
a) diisocyanates,
b) diols of which
b1) from 10 to 100 mol %, based on the total amount of diols (b), have a molecular weight of from 500 to 5 000, and
b₂) from 0 to 90 mol %, based on the total amount of diols (b), have a molecular weight of from 60 to 500 g/mol,
c) monomers other than the monomers (a) and (b), containing at least one isocyanate group or at least one isocyanate-reactive group and further carrying at least one hydrophilic group or potentially hydrophilic group by means of which the polyurethane is made dispersible in water,
d) if appropriate, further, polyfunctional compounds other than the monomers (a) to (c), containing reactive groups which are alcoholic hydroxyl groups, primary or secondary amino groups or isocyanate groups, and
e) if appropriate, monofunctional compounds other than the monomers (a) to (d), containing a reactive group which is an alcoholic hydroxyl group, a primary or secondary amino group or an isocyanate group,
wherein the diols b₁ comprise less than 0.5 part by weight of cyclic compounds per 100 parts by weight of diols b1.

2. The aqueous dispersion according to claim 1, wherein diisocyanates (a) used comprise 1-isocyanato-3,5,5-trimethyl-5-isocyanatomethylcyclohexane (IPDI), tetramethylxylylene diisocyanate (TMXDI), and bis(4-isocyanatocyclohexyl)-methane (HMDI).

3. The aqueous dispersion according to claim 1, wherein at least 50% by weight of the diols (b1) comprise polyesterdiols or polytetrahydrofuran.

4. A method of coating an article made of metal, plastic, paper, textile, leather or wood, which comprises applying an aqueous dispersion according to claim 1 in the form of a film to said article and drying the dispersion.

5. A method of adhesively bonding an article made of metal, plastic, paper, textile, leather or wood, which comprises applying an aqueous dispersion according to claim 1 in the form of a film to one such article and joining said article to another article before or after drying the film.

6. A method of impregnating an article made of textile, leather or paper, which comprises soaking said article with the aqueous dispersion according to claim 1 and then drying it.

7. An article coated, adhesively bonded or impregnated with the aqueous dispersion according to claim 1.

8. The method of using the aqueous dispersion according to claim 1 as a coating for an article made of metal, plastic, paper, textile, leather or wood.
